(19) United States
(12) Patent Application Publication
(10) Pub. No.: US 2008/0271670 A1
(43) Pub. Date: Nov. 6, 2008

(54) Painting Installation

(75) Inventor: Hubert Croly Labourdette, Cergy Saint-Christophe (FR)

Correspondence Address: Young & Thompson, 209 Madison Street, Suite 500, Alexandria, VA, 22314, US

(73) Assignee: ABB FRANCE, Rueil Malmaison (FR)

(21) Appl. No.: 12/066,086

(22) PCT Filed: Aug. 29, 2006
(86) PCT No.: PCT/FR2006/002000

§ 371 Date: Mar. 7, 2008

(30) Foreign Application Priority Data
Sep. 7, 2005 (FR) 05 09140

(51) Int. Cl. B05C 5/00

(52) U.S. Cl. 118/313

(57) ABSTRACT

A painting installation includes at least one painting cabin (10) through which each part (9) for painting passes, the cabin being defined by side walls (2) between a top distributor for blowing air and bottom elements for recovering and treating air carrying particles of paint, the cabin also being provided with at least one applicator (5) for applying paint to the part (9), the applicator possessing a plurality of degrees of freedom, and with a conveyor (7) for conveying the part, the conveyor possessing a number of degrees of freedom that is smaller than that of the applicator. According to the invention, while the part is present in the cabin, the position of the part in the frame of reference of the cabin is controlled by the position of the applicator in the frame of reference by programmable elements for servo-controlling the motor (11) of the conveyor to the applicator.

The present invention relates to an in-line painting installation, in particular for painting motor vehicle components.

### BACKGROUND OF THE INVENTION

For many years, motor vehicle bodywork components have been painted in-line. Each component passes in succession through a plurality of cabins for preparing, applying, drying, . . . purposes.

The main concerns of operators in the field of painting are associated firstly with reducing energy consumption in operation and secondly with ensuring line flexibility. An important factor in energy expenditure stems from creating and maintaining a vertical flow of air sweeping through a paint application station so as to limit as much as possible any contamination of elements of the line by particles of paint that are in suspension in the air and that have not become deposited on an article for painting. These particles are entrained downwards by a vertical flow of air sweeping through the entire volume of the painting station, the stream of air heading into a bottom cabinet where it is subjected to treatment, serving firstly to separate the paint out from the air, and secondly to adjust its humidity so that, in particular, it can advantageously be recycled. The energy expended in blowing the air constitutes an operating expense that it is advantageous to minimize.

Concerning flexibility, users seek the greatest possible diversity in articles for painting that can travel along the same line. In other words, the painting line is advantageous if it enables parts of some other type to be accepted merely by simple operations of changing the programming of the painting robot and of the part-supporting conveyors.

Present painting lines can be classified into two main categories:
those in which a continuous conveyor causes parts to travel through various successive stations; movement is then continuous and the travel speed is that imposed by the station having the cycle time that is the longest, with the robots being stationary or accompanying the conveyor at least in part through each station; and
those in which the parts are conveyed in discontinuous manner, parts being processed in successive stations while they are stationary, with the processing robots moving around the stationary parts; all of the parts are then transferred to the next station.

Neither of those two categories presents an advantage that is decisive in terms of flexibility.

### OBJECT OF THE INVENTION

The invention satisfies the expectations of users better than existing installations both from the point of view of economy and from the point of view of flexibility, while presenting operating flexibility that enables cycle times to be reduced as much as possible.

### BRIEF SUMMARY OF THE INVENTION

Thus, the invention provides a painting installation comprising at least one painting cabin through which each part for painting passes, the cabin being situated between a top distributor manifold for blowing air and bottom means for collecting, recovering, and treating air carrying particles of paint, the cabin also being provided with at least one applicator for applying paint to the part, the applicator possessing a plurality of degrees of freedom, and with a conveyor for conveying the part, the conveyor possessing a number of degrees of freedom that is smaller than that of the applicator.

According to the invention, while the part is present in the cabin, the position of the part in the frame of reference of the cabin is controlled by the position of the applicator in said frame of reference by programmable means for servo-controlling the motor of the conveyor to the applicator.

One of the results of this servo-control connection between the conveyor and the applicator (which may be performed point by point: each point of the applicator corresponding to a position of the conveyor) is that it makes it possible to confine the relative movements of the part and of the applicator in a space of volume that is as small as possible. Consequently, extensions of the robot arm forming part of the applicator can be minimized to such an extent that is it is possible to limit the movements of the applicator to within a sector in three dimensions that presents an angle that is narrower than that previously required. Thus, the applicator can be housed in a corner of a cabin, thereby enabling the ground area occupied by the cabin to be reduced, and thus enabling the section of the volume swept by the flow of air to be reduced. As a result, other things being equal, energy savings are achieved.

The vertical walls that define such a cabin can then diverge going away from the entry into the cabin and converge going towards its exit, the applicator being housed in the vicinity of one of these oblique walls.

It should be observed that the greatest amount of confinement is obtained when the painting applicator is stationary and all of the degrees of freedom relating to the part for painting and relative to the applicator are carried by the conveyor of the part. However that is a theoretical condition that does not correspond to reality on a painting line. Such a conveyor would need to be constituted by a robot having at least at six axes. The expense of that solution would be completely unacceptable. Furthermore, it is not possible to envisage providing robots capable of handling an entire vehicle body, even though the invention is suitable for use therewith. Finally, such a conveyor robot would necessarily be exposed to contamination and the cost of maintaining it would also be very high.

In reality, the invention takes account of the fact that the conveyor in each cell is a simple self-contained conveyor, e.g. made up of a table on wheels. The degrees of freedom presented by the part in the cabin are those of the conveyor, enabling the conveyor to move forwards, to stop, and to reverse. In a more elaborate version, one or two rotations can be added enabling the part to turn about a vertical pivot perpendicular to the travel direction of the base conveyor. In any event, it is appropriate to ensure that the conveyor for conveying the part through the cabin is as simple as possible in order to facilitate maintenance. Servo-controlling the motor of the conveyor as a function of the position of the applicator also presents the advantage of enabling parts of different shapes to be processed in the same painting cabin. The path of the applicator is trained or programmed, and starting from this new path for a new part, it suffices to modify the parameters of the servo-control over the operation of the conveyor to said new path in order to obtain the desired result.

Furthermore, the invention makes it possible to save at least some of the time needed either while transferring a part from one station to another or while changing color from one part to another.

Preferably, each cabin has two independent conveyors controlled by the applicator, thus enabling cycle times to be optimized.

The paint installation of the invention lends itself advantageously to modularization. The sweeping air requirements are small enough to enable the installation for treating the air, and in particular including separating out the paint, to be contained in a basement of the cabin that can be fitted within the horizontal dimensions of the cabin, so that the cabin and its basement constitutes a self-contained unit fitted within a structure that is substantially rectangular and in which it is also possible to include ducts for transferring recycled air between the basement and the top distributor manifold.

Other characteristics and advantages of the invention appear from the following description of embodiments given purely by way of indication.

### BRIEF DESCRIPTION OF THE DRAWINGS

Reference is made to the accompanying drawings, in which:

FIG. 1 is a diagram in horizontal section showing a cabin of the state of the art;

FIG. 2 is a diagram of a cabin in horizontal section in accordance with the installation of the invention;

FIG. 3 is a diagram in vertical section of a cabin in accordance with the installation of the invention; and

FIG. 4 is a diagram in horizontal section of two adjacent cabins in accordance with an installation of the invention.

### DETAILED DESCRIPTION OF THE INVENTION

FIG. 1 shows a painting cabin 1 defined by vertical partitions 2 having an entry 3 and an exit 4. Inside the cabin, there is a painting robot 5 having five or six degrees of freedom and carrying at its end an applicator (not shown) such as a gun or a rotary pole for spraying paint. Such spraying is generally performed in an electrostatic field so as to create a first confinement of the jet, with droplets tending to follow the field lines that become established between the applicator, which is at a positive voltage and the article for painting which is at ground potential.

The article for painting is carried by a support 6 that has entered the cabin via the entry 3 and that is secured to a conveyor 7 inside the cabin, enabling the support 6 to be moved inside the cabin in the travel direction A of the articles through the paint line. The applicator robot 5 is housed in an alcove 8, and its sweep angle is represented by angle D in FIG. 1. This is the angle needed by the rotor to enable its applicator to perform all of the work required thereof from the article for painting entering the cabin and until it leaves it. This sweep angle, which is naturally associated with all of the extensions needed by the robot arm in order to apply paint, defines a three-dimensional zone that becomes contaminated with the paint that is not applied to the article for painting. The extent of this zone defines the positioning of the vertical partitions 3 of the cabin within which a vertical flow of air is organized specifically for collecting the contaminating particles of paint.

It has been observed that by organizing the relative movement between the applicator and the part in a manner that is different from that which is presently in existence, and in particular by using the degrees of freedom of the part-carrying conveyor better than they are used at present (advance, stop, or travel continuously), it is possible to reduce the size of this zone of contamination, thereby reducing the size of the cabins and thus the magnitude of the flow of sweeping air needed for proper operation thereof.

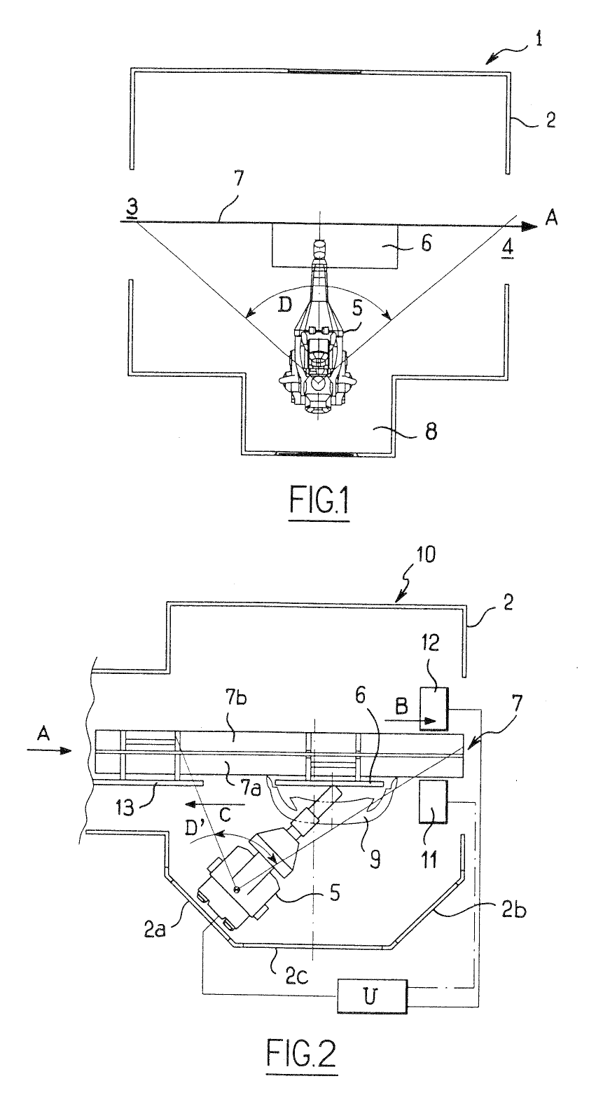

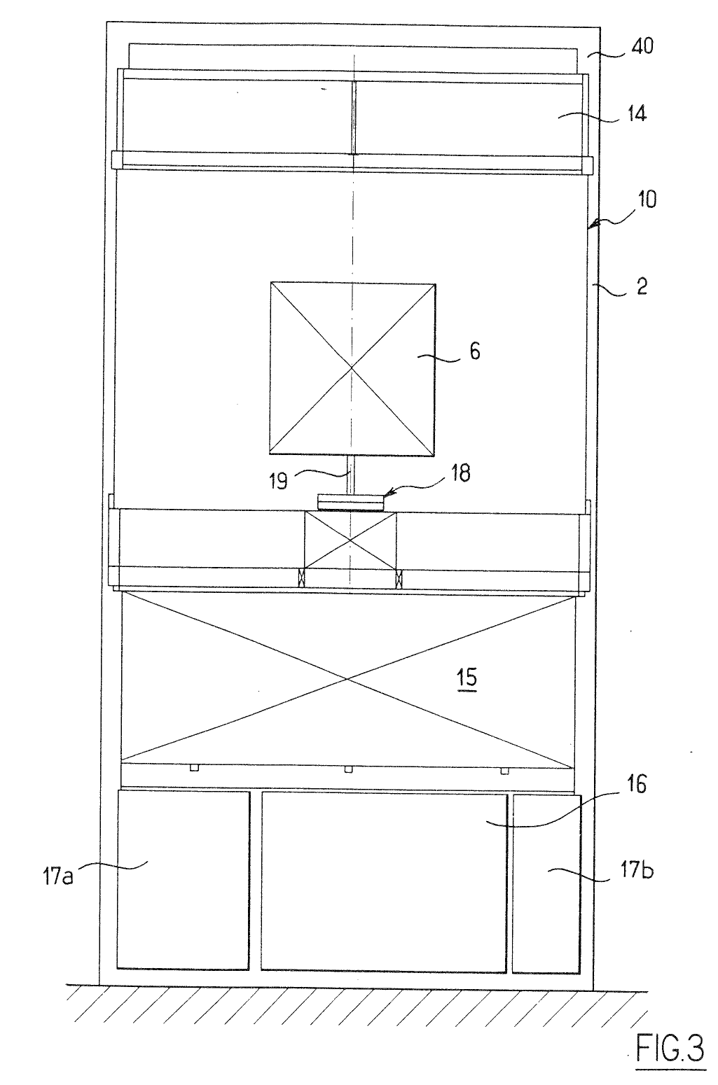

FIG. 2 shows a painting cabin 10 made in accordance with the invention. By servo-controlling the movement of the conveyor 7 to the position of the paint applicator, it will be understood that it is possible to reduce the amplitude of the angle D. This servo-control may consist, for example, in causing each point of the path followed by the applicator in the frame of reference of the cabin to correspond to a point of the path followed by the conveyor in said frame of reference. This makes it possible to reduce the working length of a cabin and thus to reduce its horizontal section. It is also possible to take advantage of the reduction in the amplitude of this angle D to modify the position of the applicator robot 5, in particular by placing it in a corner of the cabin, as shown in FIG. 2, thus making it possible to find a compromise between reducing the length of the cabin in the travel direction A of the conveyor, and reducing the width of the cabin, since this makes it possible to eliminate the alcove 8 of FIG. 1. In other words, the angle D′ shown in FIG. 2 is not the smallest angle that could be achieved by applying the means of the invention, but constitutes a compromise between such a minimum value and the value D of the state of the art whereby it is also possible to reduce the width of the cabin.

FIG. 2 shows vertical walls 2a and 2b that form converging and diverging truncated corners. These walls 2a and 2b may include hatches for providing openings giving access to the inside of the cabin or to the applicator head of the robot. Windows 2c may be provided in other portions of the walls 2.

FIG. 2 also shows the support 6 of an article 9 for painting and the servo-control means U for controlling the operation of a drive motor 11 for the conveyor 7 on the position in three dimensions of the applicator robot 5.

In a preferred embodiment, the conveyor 7 is actually made up of two motor-driven conveyors 7a and 7b with two motors 11 and 12, the support 6 being secured to the conveyor 7a while a support 13 following the support 6 is secured to the conveyor 7b. The motor 12 of the conveyor 7b is also servo-controlled in operation by the programmable unit U to the position of the applicator robot 5. By virtue of this disposition, it is possible to achieve better control over the relative position of two consecutive supports 6 and 13 so as to optimize working times by preparing the arrival of an article secured to the support 13 in concurrent time while the article 9 on the support 6 is being subjected to painting treatment. The servo-control of the motors 11 and 12 serve to obtain varying speeds in a direction B or in the opposite direction C for each of the conveyors 7a and 7b, and also stationary periods.

FIG. 3 is a vertical section through a cabin 10 as shown in FIG. 2. It can be seen that the cabin as defined by the walls 2 possesses an air-blowing distributor manifold 14 in its top portion and a unit 15 in its bottom portion for washing the blown air to remove the particles of paint therefrom that it is carrying, the unit 15 being connected both to vessels 16 for recovering paint and the agents conveying it, and also to an installation 17a, 17b for treating and recycling the blown air which can then be returned towards the top manifold 14. It should be observed that only one conveyor 7 is shown in the figure and that it includes means 18 serving to vary the orientation of the support 6 carrying the article for painting about a vertical axis 19.

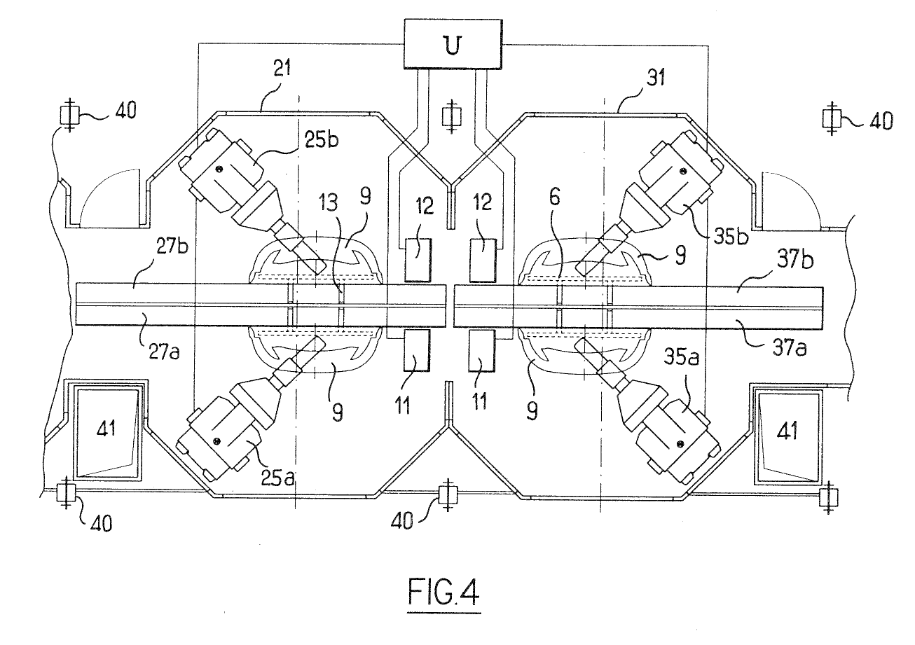

Finally, FIG. 4 shows some of the same elements as described above, and given the same references.

This figure shows two successive cabins 21 and 31, each possessing two applicator robots such as 25a and 25b for the cabin 21 and 35a and 35b for the cabin 31 that are disposed in a mirror image configuration to each other about a longitudinal plane of symmetry parallel to the travel direction of the parts 9. With these duplicated robots, it is possible in one cabin to process twice as many parts in a given cycle time while optimizing the horizontal section of the cabin. If the articles 9 in the cabin 31 are secured to a support 6, itself coupled to the conveyor 37a of that cabin, then the articles 9 being processed in the cabin 21 are carried by a support 13 coupled to the conveyor 27b of that cabin 21 such that when these parts reach the cabin 31, the support 13 will be taken over by the conveyor 37b that is distinct from the conveyor 37a so as to make it possible to adjust for the best the relative positions of the parts entering the cabin 31 and the parts being processed therein. In FIG. 4, there can be seen the vertical uprights 40 of a generally rectangular structure, each upright 40 being suitable for assembly to a corresponding upright of an adjacent module, with each module comprising, as shown in FIG. 3, a cabin, a top air-blowing distributor manifold, a unit for treating blown air carrying paint with the paint being separated out and the air being recycled, this processor unit forming the basement of the cabin and the module also having ducts 41 for recycling the air as treated in the basement back towards the top distributor manifold.

By means of this modular structure, it is entirely possible to transform an existing line, e.g. having two adjacent cabins 21 and 31 as shown in FIG. 4 by extracting from the line the module carrying the cabin 31, e.g. for the purpose of replacing it with a switching module (a carousel) providing an outlet for the cabin 21 and three inlets for three parallel or secondary processing lines in order to be able to handle changes to the installation as required by the user.

1-7. (canceled)

8. A painting installation comprising at least one painting cabin (10) through which each part (9) for painting passes, the cabin being defined by side walls (2) between a top distributor (14) for blowing air and bottom means (15, 16, 17a, 17b) for recovering and treating air carrying particles of paint, the cabin also being provided with at least one applicator (5) for applying paint to the part (9), the applicator possessing a plurality of degrees of freedom, and with a conveyor (7) for conveying the part (9), the conveyor possessing a number of degrees of freedom that is smaller than that of the applicator (5), wherein while the part is present in the cabin, the position of the part (9) in the frame of reference of the cabin is controlled by the position of the applicator (5) in said frame of reference by programmable means for servo-controlling the motor (11) of the conveyor to the applicator.

9. An installation according to claim 8, wherein the applicator (5) is placed in a corner of the side walls of the cabin.

10. An installation according to claim 8, wherein the side walls (2) of the painting cabin include, in the travel direction (A) of the part, a diverging portion (2a) at the entry (3) of the cabin, and a converging portion (2b) at the exit (4) from the cabin, the applicator (5) being adjacent to one of these inclined portions.

11. An installation according to claim 10, wherein some of the converging and/or diverging portions (2b, 2a) of the cabin walls include openings giving access to the inside of the cabin or the active head of the applicator (5).

12. An installation according to claim 10, wherein the other portions of the cabin are provided with windows.

13. An installation according to claim 8, wherein the cabin includes two conveyors (7a, 7b) servo-controlled to the applicator (5).

14. An installation according to claim 8, wherein the cabin belongs to an independent module having a basement containing the means for treating and recycling air (15, 16, 17a, 17b), and a top containing means (14) for distributing blown air, and ducts (41) for transferring the recycled air from the basement to the top distributor (14).
